(19) United States
(12) Patent Application Publication
(10) Pub. No.: US 2014/0142998 A1
(43) Pub. Date: May 22, 2014

(54) Method and System for Optimized Task Assignment

(71) Applicant: FMR LLC, Boston, MA (US)

(72) Inventors: Keith Kroeger, Renmore (IE); Igor Nikolaev, Galway (IE)

(73) Assignee: FMR LLC, Boston, MA (US)

(21) Appl. No.: 13/680,595

(22) Filed: Nov. 19, 2012

(51) Int. Cl. G06Q 10/06

(52) U.S. Cl. 705/7.13

(57) ABSTRACT

A computer-implemented method is provided for assigning tasks to resources. The method includes receiving one or more constraints corresponding to each of the tasks and one or more constraints corresponding to each of the resources. The method also includes receiving a value from a user defining at least one of a plurality of variables including: (i) a resource variable representing resources available for allocation to the tasks, (ii) a duration variable representing a time frame for completing the tasks, and iii) a scope variable representing one or more of the plurality of tasks requiring execution. The method further includes applying a first optimization scheme to determine a value for each undefined variable to formulate a task delivery plan and applying a second optimization scheme to determine a task for assignment to a resource.

### FIELD OF THE INVENTION

The invention relates generally to computer-implemented methods and apparatuses, including computer program products, for optimizing assignment of tasks to resources, and more particularly, to optimizing task assignment with respect to one or more user-defined objectives and constraints.

### BACKGROUND OF THE INVENTION

Project management involves, in part, planning, organizing, securing and/or managing resources to bring about the successful completion of a project with respect to specific project goals and objectives. Project managers can manage resources using, for example, a well known Agile development approach. See., e.g, “Agile Software Development: A gentle introduction” at http://www.agile-process.org/. An Agile approach is characterized by factors such as relatively short time-frame intervals (often referred to as sprints or iterations), delivery of certain goals at the end of each iteration, and regular adaptation of requirements and designs in response to changing circumstances.

Under Agile development methods, a project can be organized into one or more features with each feature delivering a package of related functionalities that an end user generally expects to get all at once. In turn, each feature can be broken down into a collection of related stories with each story defining a particular functionality. For example, given a feature involving programming inline table resizing, it can be broken down into three stories—resizing columns, resizing rows and resizing the table itself. Each story can be further decomposed into one or more tasks. In addition, a working feature or product can be produced at the end of a release, during which the feature or product is refined through successive iterations. Typically, each iteration involves a team working through a full development cycle including planning, designing and testing phases. Thus, Agile methods minimize overall risks by allowing a project to adapt to changes quickly.

In an Agile environment, after each task is scheduled to execute in a certain iteration or release, systems and methods are needed to manage real-time execution of the tasks, such as assigning a task to an appropriate resource (e.g., a developer) for completion. Usually, a typical Kanban approach can be used to perform such task assignment. See, e.g., https://leankitkanban.com/. This is a management method with an emphasis on just-in-time delivery while not overloading the workers. It requires the workers to pull new work from a single queue on a first-come-first-serve basis when the workers have availability, which limits the work-in-progress at any given time. The traditional single-queued Kanban approach, while useful, has numerous shortcomings, one of which is its inability to account for different skill levels required to perform different tasks, thus can produce inefficient assignments as a result. In addition, the traditional Kanban approach cannot accommodate dynamic changes associated with resource allocation, such as using optimization techniques to assign tasks to resources to meet any changing goals.

### SUMMARY OF THE INVENTION

Methods and apparatuses are provided to manage execution of tasks in a project, such as tasks defined by an Agile model. In some embodiments, methods and apparatuses of the present invention employ an improved Kanban approach to assign tasks to resources to optimize project performance. The improved Kanban approach of the present invention uses optimization techniques to determine task assignments by considering a variety of factors including, for example, past performance of individual workers and/or past performance of the entire team. The optimization techniques can be implemented using linear and/or constraint programming. In addition, methods and apparatuses of the present invention can determine a plan of task delivery based on a few user-defined variables, such as resources, scope and duration. This plan provides a user with a delivery forecast quickly and can be easily adjusted to model any changes to the plan horizon. Hence, the present invention can efficiently highlight bottlenecks in a project, such as areas where tasks are taking longer than necessary to finish.

In some embodiments, the present invention is used in an Agile environment to generate a delivery plan and perform assignment of Agile tasks. By combining the improved Kanban method with an Agile approach for scheduling tasks, the methods and apparatuses of the present invention facilitate execution of tasks in short-term iterations to i) quickly complete functionalities and deliver them to customers and ii) quickly react to changes to reduce overall planning time. However, the methods and apparatuses of the present invention can also be used in other project management approaches that require resource allocation.

In one aspect, a computer-implemented method is provided for assigning a plurality of tasks to a plurality of resources. The method includes receiving, at a computing device, one or more constraints corresponding to each of the plurality of tasks and one or more constraints corresponding to each of the plurality of resources. The method also includes receiving, at the computer device, a value from a user defining at least one variable in a plurality of variables including: (i) a resource variable representing resources available for allocation to the plurality of tasks, (ii) a duration variable representing a time frame for completing the tasks, and iii) a scope variable representing one or more of the plurality of tasks requiring execution. The method further includes applying, using the computer device, a first optimization scheme to determine a value for each undefined variable from the plurality of variables. Applying the first optimization scheme solves a first objective function subject to the define variable while satisfying i) the one or more constraints corresponding to each task and ii) the one or more constraints corresponding to each resource. The method also includes formulating, using the computer device, a task delivery plan based on the plurality of variables after they are defined. The method additionally includes applying, using the computer device, a second optimization scheme to determine a first task from the plurality of tasks for assignment to a first resource. Applying the second optimization scheme solves a second objective function while satisfying i) the task delivery plan, ii) one or more constraints associated with the first task, and iii) one or more constraints associated with the first resource.

In another aspect, a computer program product, tangibly embodied in a non-transitory machine-readable storage device, is provided for assigning a plurality of tasks to a plurality of resources. The computer program product includes instructions being operable to cause data processing apparatus to receive one or more constraints corresponding to each of the plurality of tasks and one or more constraints corresponding to each of the plurality of resources. The computer program product includes instructions being operable to cause data processing apparatus to receive a value from a user defining at least one variable in a plurality of variables including: (i) a resource variable representing resources available for allocation to the plurality of tasks, (ii) a duration variable representing a time frame for completing the tasks, and iii) a scope variable representing one or more of the plurality of tasks requiring execution. In addition, the computer program product includes instructions being operable to cause data processing apparatus to apply a first optimization scheme to determine a value for each undefined variable from the plurality of variables. Applying the first optimization scheme solves a first objective function subject to the at least one defined variable while satisfying i) the one or more constraints corresponding to each task and ii) the one or more constraints corresponding to each resource. Furthermore, the computer program product includes instructions being operable to cause data processing apparatus to formulate a task delivery plan based on the variables after they are defined and apply a second optimization scheme to determine a first task from the plurality of tasks for assignment to a first resource. Applying the second optimization scheme solves a second objective function while satisfying i) the task delivery plan, ii) one or more constraints associated with the first task, and iii) one or more constraints associated with the first resource.

In other examples, any of the aspects above can include one or more of the following features. In some embodiments, the second optimization scheme is applied to determine a second task from the plurality of tasks for assignment to a second resource. Applying the second optimization scheme solves the second objective function while satisfying i) the task delivery plan, ii) one or more constraints associated with the second task and iii) one or more constraints associated with the second resource.

In some embodiments, the resources comprise human resources and the one or more constraints corresponding to each human resource include performance constraints. The performance constraints can be determined based on historical performance data associated with the respective human resource. In some embodiments, the resources comprise one or more human resources, one or more physical resources, or a combination thereof. In some embodiments, the resources comprise one or more physical resources including one or more computer resources, one or more geographic locations, one or more supply materials, one or more equipment items, or a combination thereof. In some embodiments, the one or more constraints corresponding to each resource comprise a skill level of each team member, availability of each team member, past performance rating of each team member, or a combination thereof.

In some embodiments, the one or more constraints corresponding to each task include a start date or date range, an end date or date range, a resource constraint, a cost constraint, a location constraint, a dependency constraint, or a combination thereof.

In some embodiments, the duration variable and the resource variable are defined by the user, based on which the first optimization scheme determines a value for the scope variable. In this case, the first objective function can be configured to maximize the number of critical tasks, maximize the number of tasks with highest business value, maximize the number of tasks with highest return-on-investment, minimize the number of tasks with highest risk, or a combination thereof.

In some embodiments, the resource variable and the scope variable are defined by the user, based on which the first optimization scheme determines a value for the duration variable. In this case, the first objective function can be configured to minimize the time for completing the tasks.

In some embodiments, the duration variable and the scope variable are defined by the user, based on which the first optimization scheme determines a value for the resource variable. In this case, the first objective function can be configured to minimize resource fragmentation, minimize resource cost, or a combination thereof.

In some embodiments, the second objective function is configured to minimize the amount of time to complete the plurality of tasks.

In some embodiments, the first and second objective functions are the same function. The first and second objective functions can also be different functions.

In some embodiments, the first optimization scheme completes the task delivery plan by defining each variable from the plurality of variables that is not defined by the user. The second optimization scheme can then assign tasks to resources to meet the task delivery plan generated by the first optimization scheme.

In some embodiments, at least one of linear programming or constraint programming is used to solve at least one of the first optimization scheme or the second optimization scheme.

In some embodiments, the first or second objective function is formulated based on at least one optimization goal supplied by the user.

It should also be understood that various aspects and embodiments of the invention can be combined in various ways. Based on the teachings of this specification, a person of ordinary skill in the art can readily determine how to combine these various embodiments. For example, in some embodiments, any of the aspects above can include one or more of the above features. One embodiment of the invention can provide all of the above features and advantages.

### BRIEF DESCRIPTION OF THE DRAWINGS

The advantages of the technology described above, together with further advantages, may be better understood by referring to the following description taken in conjunction with the accompanying drawings. The drawings are not necessarily to scale, emphasis instead generally being placed upon illustrating the principles of the technology.

FIGS. 1A and B show flowcharts depicting an exemplary process for assigning tasks to one or more resources.

FIGS. 2A-C show flowcharts depicting an exemplary process for resource allocation in an Agile environment using the process of FIGS. 1A and B.

FIG. 3 shows a block diagram illustrating an exemplary design of a management system according to some embodiments of the present invention.

### DESCRIPTION OF THE INVENTION

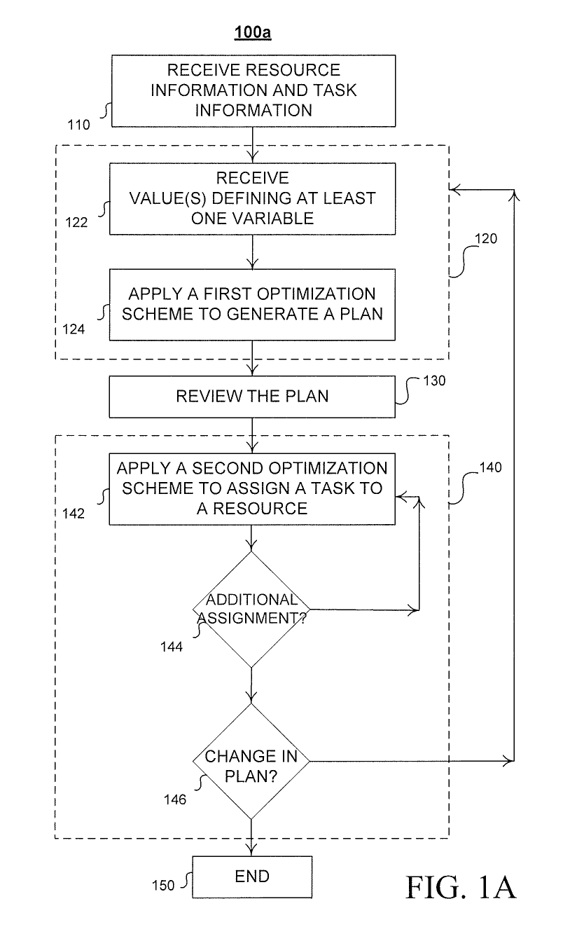

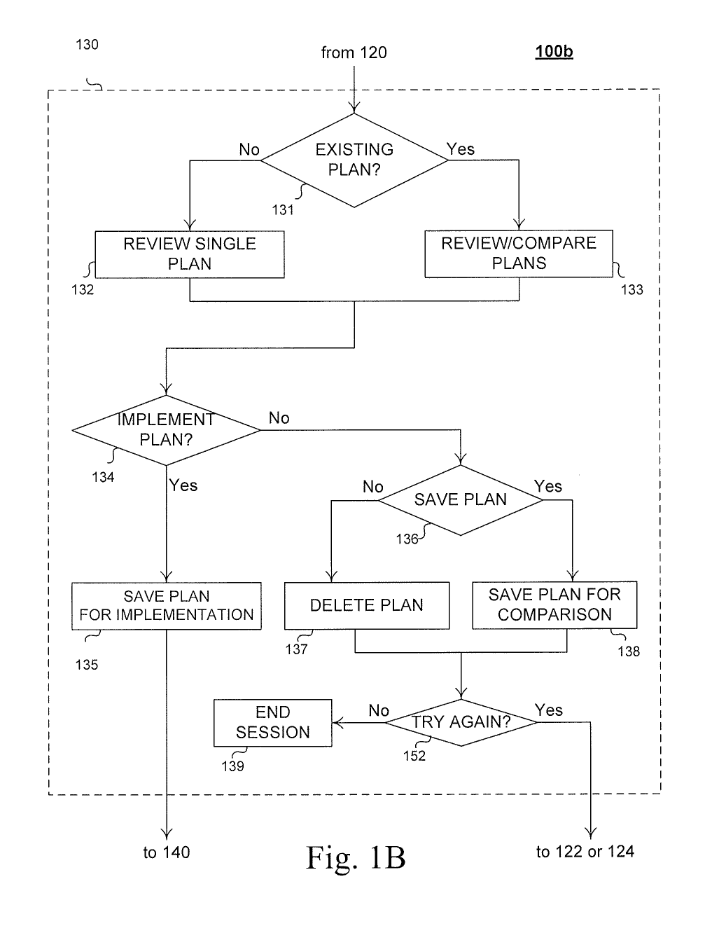

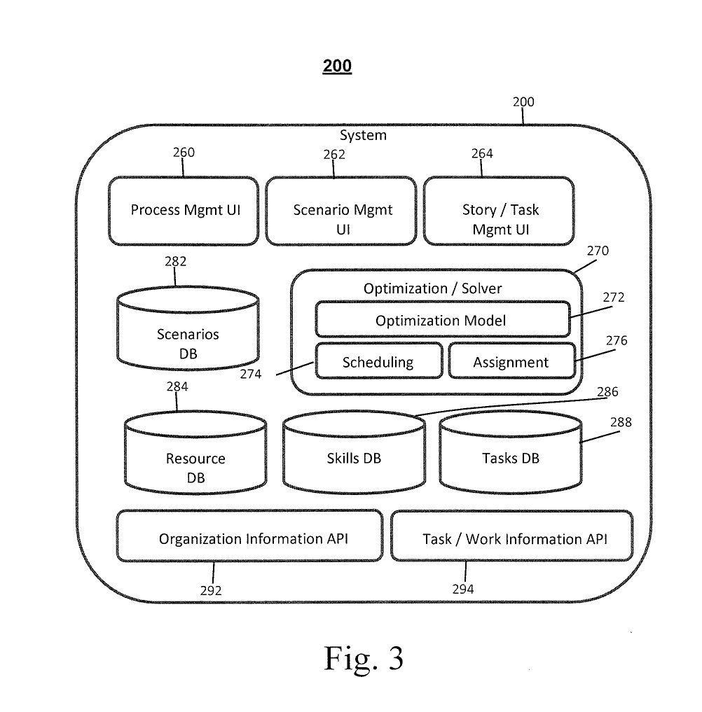

FIG. 1A shows a flowchart 100a depicting an exemplary process for assigning tasks to one or more resources. The elements of the flowchart 100a are described using the exemplary management system 200 of FIG. 3. The process is generally divided into four steps—receiving resource information and task information (step 110), producing a general plan for delivering tasks (step 120), reviewing the plan (step 130), and performing allocation of resources to tasks based on the plan (step 140). The plan generation process (step 120) can include receiving value(s) defining at least one variable in a group of variables (step 122), and applying a first optimization scheme to generate a plan for delivering the tasks based on the received data (step 124). The task assignment process (step 140) can include applying a second optimization scheme to assign a task to an available resource based on the delivery plan and the received data (step 142), determining whether there are additional assignments required (step 144), and determining whether there are any changes to the plan (step 146). The process ends (step 150) when no more unassigned resources and/or tasks remain.

Resource information provided to and received by the management system 200 (step 110) can define resources that are available for allocation to one or more tasks and can include resource-related constraints. Task information that are provided to and received by the management system 200 (step 110) can define one or more tasks for which resource allocation is required and can include task-related constraints. Resource allocation can involve suitable assignment of a task to a resource such that one or more task-related constraints and/or resource-related constraints are satisfied. In general, the constraints can be provided and/or received as a data structure such as, for example, textual lists, XML documents, class objects (e.g., instances of C++ or Java classes), other data structures, or any combination thereof.

Resource information can represent a plurality of resources, which can range from human personnel (e.g., computer programmers, accountants, employees, consultants, etc.) to physical resources (e.g., a computer resources, infrastructure resources such as a geographic locations or buildings/office space, any type of supply or manufacturing material, physical equipment items, etc.). Constraints on resources can include one or more of any of the following: type attributes (e.g., full-time employee, part-time employee, contractor, temp, etc.), role attributes (e.g., workflow manager, architect, analyst, QA engineer, database manager/administrator, computer programmer), role-level attributes (e.g., a principal role, a senior role, an entry-level role, a graduate role, etc.), skill attributes (e.g., Java, C++, or generally any knowledge/ability to undertake a required activity), geographic attributes (e.g., one or more cities/countries or other locations where person is available to work), education attributes (e.g., Ph.D., M.B.A., J.D., etc.), language attributes (e.g., French, German, etc.), cost attributes (e.g., $/hour), experience attributes (e.g., years of experience working on regulatory compliance), fungibility, human fragmentation attributes (e.g., the capability to be assigned to multiple tasks), security attributes (e.g., security clearance, etc.), criticality attributes (e.g., a measure of the importance of a human resource), historical performance attributes (e.g., performance metrics of a human resource based on historical performance data) and/or any combination thereof. In some embodiments, resource-related constraints include attribute information about a team of employees, such as average historical performance attributes for the team, average cost attributes for the team, etc.

Resource-related constraints can also define one or more of any of the following: geographic attributes (e.g., one or more locations where physical resource can be used or accessed), cost attributes (e.g., cost to use per hour, cost of supply per unit, etc.), availability attributes (e.g., information indicating times/dates and/or locations that the resource is available for use and not yet assigned), supply attributes (e.g., amount of supply), throughput attributes (e.g., network bandwidth, system capacity, physical space, etc.), security attributes, and/or any combination thereof. In some embodiments, the resource-related constraints can include both constraints on human personnel and physical resources in any combination thereof.

Task information, including task-related constraints, can define tasks that require resource allocation. Task-related constraints can include at least a starting date and an end date during which the corresponding task is expected to be completed. Task-related constraints can define the amount of resources required to complete a task. In general, task-related constraints can include one or more resource requirements, schedule requirements, cost requirements, ROI requirements, or criticality requirements, or any combination thereof.

Resource requirements associated with a task define what resources are required or can be used for the successful completion of the task. Exemplary resource requirements for a task include human utilization level, team utilization level, resource fragmentation level, and location fragmentation data. In some embodiments, a resource requirement can define a minimum or maximum number of team members required. Resource requirements can also specify a minimum level of experience, certification, and/or security clearance. Aside from resource requirements that specify a general constraint, resource requirements can also specify a specific resource (e.g., the name of a particular person or physical resource). In some embodiments, resource requirements can include an estimate of effort required to complete a task.

Schedule requirements for a task can include a start-date, an end-date, one or more milestone dates, a duration limit, or any combination thereof. Exemplary schedule requirements include earliest start date, latest finish date, or an estimate of how many days a task may take. In some embodiments, a schedule requirement can be defined as a hard constraint or an unchangeable constraint (e.g., for a high priority task, for a task in-flight, or for a task in which the investment therein has surpassed a threshold amount). In some embodiments, a date requirement for a task can be made dependent on the completion of any date or event for another task.

Cost requirements for a task can set a minimum or maximum limit on the amount of money estimated to be spent on the task. A return-on-investment (ROI) requirement can set a minimum limit on the profitability or ROI of a task.

Criticality requirements (e.g., a priority level) for tasks can be used by the management system 200 as a guide to order execution of tasks for determining which tasks are executed first. A criticality requirement can also be used to determine whether a task can be deferred to a later late or not implemented altogether if insufficient resources are available for its successful completion.

After receiving resource and task information (step 110), the management system 200 is ready to generate a plan of task delivery (step 120). To accomplish this, the management system 200 first receives value(s) defining at least one variable in a plurality of variables and at least one optimization goal (step 122). The variables, once defined, formulate a plan for delivering the tasks, such as a plan for delivering the tasks within an Agile iteration or release. The variables defining a plan can include: 1) duration—the time period for executing the plan; 2) scope—the number of tasks deliverable within the duration and their functionality; and 3) resources—the resources available to perform the tasks within the scope and over the duration.

In some embodiments, a user only supplies value(s) to fix some of the three variables required to define a task delivery plan. For example, a user supplies values for two of the three variables. In such a case, the management system 200 uses a first optimization scheme to determine the value(s) of the remaining undefined variable(s) (step 124) based on the fixed variables and at least one user-supplied optimization goal. Specifically, the management system 200 first formulates an objective function to represent the optimization goal; the objective function parameterizes all the variables. Optimization is then performed by solving the objective function to determine the undefined variable(s) subject to the fixed variables, while satisfying one or more of the task-related constraints and/or resource-related constraints. The constraints define the domain within which the solution resides. The solution of the objective function represents value(s) for those variable(s) not defined by the user.

The optimization goals supplied by the user can be used by the management system 200 to select one or more objective functions. Exemplary objective functions selectable by a user include: a utilization objective function, which can determine a value for each unfixed variable to maximize human resource utilization; a schedule objective function, which can determine a value for each unfixed variable to minimize time to complete the tasks without overshooting available resources; a risk level objective function, which can determine a value for each unfixed variable to minimize cumulative risk; a criticality objective function, which can determine a value for each unfixed variable to maximize the number of critical tasks executed; a return-on-investment (ROI) objective function, which can determine a value for each unfixed variable to maximize expected gain minus cost; a maximum-number-of-tasks objective function, which can determine a value for each unfixed variable to maximize the number of tasks deliverable in a plan.

In some embodiments, a user supplies values for the time variable and the resource variable. Subject to the fixed duration and resource variables, the management system 200 can solve an objective function to determine the scope variable (an optimal set of tasks/functionalities). The management system 200 can formulate the objective function based on at least one user-defined optimization goal, such as to execute the most number of critical tasks in a plan. For example, the following objective function can be used:

$$max ( {\sum }_{k = 1}^{n} C [ {S}_{k} ] ) , \qquad ( equation 1 )$$

where n is the number of tasks to be assigned, Sₖ represents the k^{th} task, and function C represents a task criticality function.

In some embodiments where the resource and duration variables are fixed, a different objective function can be used to determine the scope variable that optimizes a different use-specified objective. For example, a user can specify an optimization goal for determining the scope variable that maximizes the number of tasks with the highest business values executed in a plan. The corresponding objective function can be:

$$max ( {\sum }_{k = 1}^{n} B [ {S}_{k} ] ) , \qquad ( equation 2 )$$

where n is the number of tasks to be assigned, Sₖ represents the k^{th} task, and function B represents a task business value function. In another example, the user can specify an optimization goal for determining the scope variable that minimizes the risks associated with a plan. The corresponding objective function can be:

$$max ( {\sum }_{k = 1}^{n} R [ {S}_{k} ] ) , \qquad ( equation 3 )$$

where n is the number of tasks to be assigned, Sₖ represents the k^{th} task, and function R represents a task risk function. In yet another example, the user can specify an optimization goal for determining the scope variable that maximizes the ROI associated with a plan. The corresponding objective function can be:

$$max ( {\sum }_{k = 1}^{n} ROI [ {S}_{k} ] ) , \qquad ( equation 4 )$$

where n is the number of tasks to be assigned, Sₖ represents the k^{th} task, and function ROI represents a task return-on-investment function.

In some embodiments, a user supplies values for the scope variable and the resource variable. Subject to the fixed scope and resource variables, the management system 200 can solve an objective function to determine the duration variable (a time period or completion date). The management system 200 can formulate the objective function to realize a user-specified optimization goal. For example, if the optimization goal is to complete the plan as soon as possible, the following objective function can be used:

min(maxₖ₌₁ⁿ(F[Sₖ])), (equation 5)

where n is the number of tasks to be assigned, Sₖ represents the k^{th} task, and function F represents a task finish date function. As another example, if the optimization goal is to complete the plan as soon as possible with certain buffer periods added to one or more of the tasks, the following objective function can be used:

min(maxₖ₌₁ⁿ(F[Sₖ]+B[Sₖ])), (equation 6)

where function B represents a task buffer function.

In some embodiments, a user supplies values for the time variable and the scope variable. Subject to the fixed duration and resource variables, the management system 200 can solve an objective function to determine the resource variable (resources available to perform the tasks). The management system 200 can formulate the objective function based on one or more user-specified optimization goals. As one example, if the optimization goal is to minimize fragmentation of work in a plan, the following objective function can be used:

$$min ( {\sum }_{k = 1}^{n} F [ {S}_{k} ] ) , \qquad ( equation 7 )$$

where n is the number of resources to be assigned, Sₖ represents the k^{th} resource, and function F represents a resource fragmentation function. As another example, if the optimization goal is to minimize resource cost, the following objective function can be used:

$$min ( {\sum }_{k = 1}^{n} C [ {S}_{k} ] ) , \qquad ( equation 8 )$$

where n is the number of resources to be assigned, Sₖ represents the k^{th} resource, and function C represents a resource cost function.

The first optimization scheme can generate multiple plans all of which satisfy the given constraints and the objective function(s) subject to the fixed variables. In some embodiments, the management system 200 selects one plan to recommend to the user by, for example, choosing the first plan it encounters that satisfy all the optimization criteria. In some embodiments, the management system 200 presents to the user all or a portion of the plans that satisfy the optimization criteria and allows the user to select an appropriate plan to implement.

In some embodiments, a plurality of objective functions can be used to achieve multiple optimization goals. For example, objective functions in Equation 1, 2 and 3 can be used to determine a value for the scope variable that achieves a balanced optimization for task criticality, business value and risk minimization. Each objective function can also be scaled by a user-specified weight to emphasize the relative importance of each optimization objective.

In some embodiments, resources available for allocation may not be sufficient to satisfy all task demands. In such a situation, the management system 200 can defer some tasks by not including them in the value for the scope variable. Task deferral can be based on the criticality and/or priority of the tasks (e.g., tasks that are least critical are most likely to be deferred or cancelled).

After the management system 200 formulates a plan of task delivery using optimization (step 120), the management system 200 allows the user to review/approve the plan (step 130) before proceeding to assign tasks to resources in accordance with the plan (step 140). FIG. 1B shows an exemplary flowchart 100b depicting a general process associated with reviewing at least one task delivery plan (step 130). This reviewing process can include determining whether there are any existing plans (step 131) (e.g., either a baseline plan or previously simulated plans), and allowing a user to review a single plan if there are no existing plans (step 132) or allowing the user to review/compare two or more plans if there are previously saved plans (step 133). Comparing two delivery plans advantageously allows the user to determine the differences between them and/or formulate feedbacks in possibly trying to create a new delivery plan with different values for the variables and/or optimization goals. The user can determine whether to implement a particular plan (step 134). If a plan is selected for implementation, then the plan is saved for implementation (step 135) and assignment of tasks to resources can be subsequently performed based on the selected plan (step 140). If a user chooses not to implement a plan, then the user determines (step 136) whether to delete the plan (step 137) or save the plan for later comparison and/or implementation (step 138). The user can determine (step 152) whether to end the session (step 139) or to reiterate the process to try further plan simulations (step 124) and/or modify the input parameters (step 122) to simulate different plans.

Referring back to FIG. 1A, based on the plan reviewed and selected by a user (step 130), the management system 200 can proceed to perform task assignment according to the plan (step 140) by assigning a task to a resource (e.g., a team member) for execution as soon as the resource becomes available. Specifically, the management system 200 can use a second optimization scheme to determine a task for assignment to an available resource (step 142) while satisfying i) the fixed variables associated with the task delivery plan, ii) constraints associated with the available resource and iii) constraints associated with the available task. To accomplish this, the management system 200 first selects an objective function that defines an optimization objective, which can be specified by a user. The management system 200 then solves the objective function to determine a task to assign to an available resource subject to the fixed variables of the delivery plan, while satisfying constraints associated with the resource and the task.

In some embodiments, if additional assignments are required (step 144), such as if there are remaining tasks and resources that require assignment, the management system 200 applies the second optimization scheme again (step 142) for each subsequent assignment. The assignment process (step 140) can continue to perform task assignments to resources using the second optimization scheme until no resource or task remains or a stop condition is satisfied (step 144). The assignment process (step 140) can also accommodate changes in global planning. For example, during the assignment process, if the management system 200 detects (step 146) that any of the variables or optimization goals associated with the original plan has been changed, the management system 200 can re-run the planning process (step 120) to generate a new plan and perform assignment of any remaining tasks based on the new plan.

As described above, the plan, once define, is associated with three fixed variables: i) scope—the tasks to be delivered and their functionality; ii) resource—the resources available for allocation to the defined tasks and iii) duration—the duration of the plan. The constraints on resources and tasks can be supplied by a user (step 110). For example, constraints associated with a resource can include a skill and/or experience level of a human resource. Constraints associated with a task can include required human skill and/or experience level to complete the task and dependencies of the task (e.g., on the completion of another task). The optimization goals for the second optimization scheme can also be user-specified, based on which the management system 200 formulates an objective function. The objective function for the second optimization scheme can be the same as or different from the object function associated with the first optimization scheme. As an example, the objective function of the second optimization scheme can be defined to reduce the number of working days, as shown below:

maxₙ₋₁ⁿ(F[tₖ]),

where n is the number of tasks remaining, tₖ represents the k^{th} remaining task, and function F represents a task finish date function. By solving this objective function, the management system 200 can determine an appropriate task to assign to an available resource to optimize the number of days to complete the remaining tasks while satisfying the delivery plan and constraints associated with the resource and the task.

This assignment process (step 140) improves the traditional Kanban assignment approach, which provides a single queue of available resources for assignment with each resource receiving a task assignment on a first-come-first-serve basis. Hence, the typical Kanban process assumes that all the resources have the same attributes, e.g., the same skill level and experience level. In contrast, the assignment process of the present invention uses optimization to generate multiple queues of available resources grouped based on different constraints/attributes. Tasks are assigned to the multi-queued resources to satisfy task-related constraints and resource-related constraints. In addition, the assignment process (step 140) can perform task assignments to comply with a general plan of task delivery, which is a feature absent in the traditional Kanban approach.

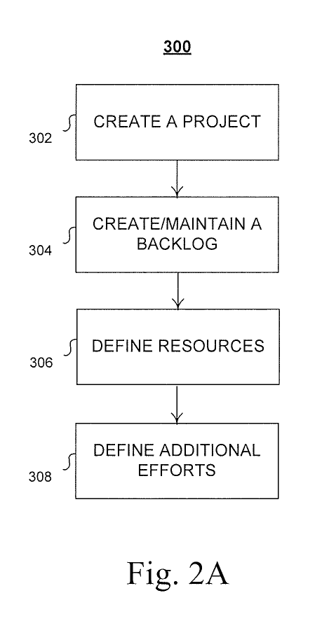

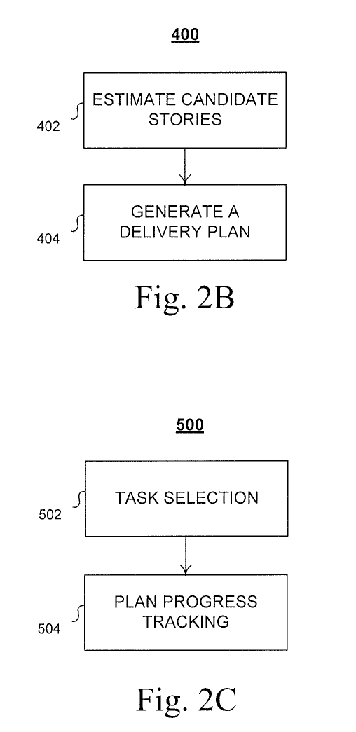

FIGS. 2A-C show flowcharts depicting an exemplary process for resource allocation in an Agile environment integrating the process of FIGS. 1A and B. The process is divided into three stages: i) a setup stage illustrated by flowchart 300, 2) a planning stage illustrated by flowchart 400, and 3) a task execution stage illustrated by flowchart 500.

Specifically, flowchart 300 of FIG. 2A depicts the setup stage during which the management system 200 receives pertinent data related to resource allocation and set up appropriate data storage structures in preparation for the allocation process. For example, the management system 200 can create a new project (step 302) based on user inputs specifying, for example, project name and skills or roles required for completing the project. A user can also define a backlog or a pool of stories for implementing the project (step 304). In Agile, one or more stories form a feature of a product and each story can be further decomposed into one or more tasks for performing the story. In some embodiments, a user defines a story by providing the following information for each story: story name, story description, and story attributes including risk, business value, criticality, required-by-date, etc. In addition, the user can define the resources available to execute the project (step 306). For example, the user can provide the following information for each available resource: resource name and resource-related constraints including role or skill, availability, etc. In some embodiments, a user defines a portion of the resources available for allocation or no resource at all. The management system 300 can automatically determine the resource needs of the project by solving the first optimization scheme to determine a value for the resource variable (step 120), if the user defines at least the scope variable. The user can also define additional efforts associated with the project that are likely to utilize resources (step 308). These additional efforts, such as estimated human resource sick time and/or vacation time, can diminish resource availability. These efforts can be represented as resource-related constraints.

Flowchart 400 of FIG. 2B depicts the plan generation stage after the setup stage is completed. A user can estimate the resources required for each story in the backlog (step 402) by defining tasks for completing each story. In Agile, tasks in a story can not only be used to approximate the amount of resources required to complete the story, but also show how the story should be completed by defining dependencies, precedence or any type of relationships among the tasks. In some embodiments, the management system 200 would only allocate resources to implement a story if tasks are defined for the story. To define a task for a story, the user can enter the following information: task name, resources required to complete the task, task-related constraints (e.g., human role or skill required to complete the task), amount of effort already expended on an in-flight task, etc. Once stories in the backlog are defined by their constituent tasks, the management system 200 can generate a task delivery plan (step 404) using the plan generation process (step 120) of FIG. 1A. As described above, the task delivery plan can specify duration (effective period of delivery effort), resources (resource capacity for the delivery period), and scope (stories and/or tasks to be executed). In some embodiments, the first optimization scheme generates multiple plans for task delivery, in which case the user can pick the most suitable plan to progress. In some embodiments, a user is allowed to review and select a plan in accordance with the reviewing process of FIG. 1B (step 130).

Flowchart 500 of FIG. 2C depicts the task execution stage. As a resource becomes available, the management system 200 assigns an optimal task to the available resource (step 502) using the assignment process (step 140) of FIG. 1. In some embodiments, to avoid context-switching, each resource is assigned one task at a time. Once the resource completes the task or becomes available otherwise (e.g., being blocked from working on the task), the resource can work on another task that is optimally determined using the same assignment process (step 140). As tasks are being completed by the resources, the management system 200 can track the progress (step 504), such as comparing the progress against the current task delivery plan. To track the progress of task execution toward the delivery plan, the management system 200 can track the following elements: resources assigned to tasks, status of tasks, effort expended and remaining on each task, etc.

The management system 200 can also identify issues related to the task execution process and identify methods to resolve the issues in order to adhere to the delivery plan. For example, the management system 200 can provide a list of gaps in resources to a user that prevent the delivery plan from being successfully implemented by, for example, highlighting those resource demands that cannot be satisfied. Based on the list, the user can perform additional hiring, outsourcing, or training or revise the task delivery plan to remedy the gaps. In some embodiments, the task delivery plan generated for a particular project is saved and re-used for another project. In some embodiments, a user can change the current plan in flight while tasks are being assigned to resources under the current plan.

FIG. 3 shows a block diagram illustrating an exemplary design of the management system 200. The management system 200 includes a combination of processes and software modules to implement the functions described in flowcharts 100a, 100b, 300, 400 and 500 of FIGS. 1A-B and 2A-C, respectively.

The management system 200 can provide various interfaces to allow a user and/or administrator to define parameters for the system. As shown, the management system 200 includes a process management graphical user interface (GUI) module 260, a scenario management GUI module 262 and a task/story management GUI module 264. The process management GUI module 260 manages user access (e.g., login and/or logout), user administration (e.g., any of the administration functions associated with the support and/or management of the system), widget management (e.g., providing the end user with the capability to arrange and save preferences for display of data within the browser area), and/or other GUI services.

The scenario management GUI module 262 allows a user to create and/or alter projects. Using this interface, the user can, for example, create projects, remove projects and/or alter the content of projects, including changing the resources and tasks or stories defined for a project. The task/story management GUI module 264 allows a user to create and/or alter tasks and/or stories corresponding to a project. For example, through the task/story management GUI module 264, a user can create/alter stories, define tasks for the stories, and create associations between tasks and stories, such as define relationships among tasks within and across stories and the extent to which work can be done in parallel. In some embodiments, a user can submit to the scenario management GUI module 262 and the task/story management GUI module 264 resource information and task information defining the allocation needs of one or more projects, as described above with reference to step 110 of FIG. 1A.

In addition, the management system 200 includes an optimization solver 270 that further includes an optimization model database 272, a scheduling database 274 and an assignment database 276. The optimization solver 270 can apply a first optimization formulation, such as the first optimization formulation described above with reference to step 120 of FIG. 1A, to produce a general plan of task delivery. The optimization solver 270 can also apply a second optimization formulation, such as the second optimization formulation described above with reference to step 140 of FIG. 1A, to determine one or more potential assignment scenarios of task to resources in accordance with the general plan. The optimization model database 272 can store one or more optimization models (e.g., optimization goals and objective functions) usable in the first and second optimization formulations. The scheduling database 274 can store one or more algorithms for scheduling the general plan of task delivery. The assignment database 276 can store one or more algorithms for assigning tasks to resources.

In some embodiments, the optimization solver 270 uses mathematical programming, such as linear programming, to solve the optimization problems of the present invention. Linear programming is a technique for the optimization of a linear objective function, subject to linear equality and linear inequality constraints. In some embodiments, constraint programming and/or constraint logic programming is used by the optimization solver 270 to solve the optimization problems. Constraint programming searches for a state of a system in which a large number of constraints are satisfied at the same time. Constraint programming typically states the problem as a state of the system containing a number of unknown variables. The constraint program then can search for values for all of the variables. In some embodiments, constraint programming can include temporal concurrent constraint programming (TCC), non-deterministic temporal concurrent constraint programming (NTCC), or both TCC and NTCC. Some exemplary examples of constraint logic languages are: B-Prolog, CHIP V5, Ciao Prolog, ECLiPSe, SICStus Prolog, GNU Prolog, Oz programming language, YAP Prolog, SWI Prolog, Claire programming language, Curry programming language, and Turtle programming language. The constraints used in constraint programming can be one or more specified domains (e.g., Boolean domains, integer domains, rational domains, linear domains, finite domains, or any mixed combination thereof).

The management system 200 can include one or more databases to store input and/or output information, such as a scenario database 282, a resource database 284, a skills database 286 and a task database 288. The scenario database 282 can store i) general plans of task delivery either entered by a user or generated through optimization by the optimization solver 270 and ii) assignment scenarios of tasks to resources either entered by a user or generated through optimization by the optimization solver 270. The resource database 284 can store information related to available resources, such as the name and skills of a human resource. The skills database 286 can store and centrally manage skill information for the resources, such as the skill level corresponding to a human resource. The task database 288 can store story and task information, including relationships among tasks and stories.

The management system 200 can include one or more application program interfaces (APIs) for interfacing with external applications to extract pertinent information. For example, the management system 200 includes a organization information API 292 used to capture organization information such as resource configuration and definition from external applications. The management system 200 also includes a task/work information API 294 used to capture story, task or other work information from external applications.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system (e.g., a cloud-computing system) that includes any combination of such back-end, middleware, or front-end components. The above described techniques can be implemented as a Software-As-A-Service (SaaS) model or using a multi-tiered approach.

Communication networks can include one or more packet-based networks and/or one or more circuit-based networks in any configuration. Packet-based networks can include, for example, an Ethernet-based network (e.g., traditional Ethernet as defined by the IEEE or Carrier Ethernet as defined by the Metro Ethernet Forum (MEF)), an ATM-based network, a carrier Internet Protocol (IP) network (LAN, WAN, or the like), a private IP network, an IP private branch exchange (IPBX), a wireless network (e.g., a Radio Access Network (RAN)), and/or other packet-based networks. Circuit-based networks can include, for example, the Public Switched Telephone Network (PSTN), a legacy private branch exchange (PBX), a wireless network (e.g., a RAN), and/or other circuit-based networks. Carrier Ethernet can be used to provide point-to-point connectivity (e.g., new circuits and TDM replacement), point-to-multipoint (e.g., IPTV and content delivery), and/or multipoint-to-multipoint (e.g., Enterprise VPNs and Metro LANs). Carrier Ethernet advantageously provides for a lower cost per megabit and more granular bandwidth options.

Devices of the computing system can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer, mobile device) with a world wide web browser (e.g., Microsoft® Internet Explorer® available from Microsoft Corporation, Mozilla® Firefox available from Mozilla Corporation).

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

1. A computer-implemented method for dynamically assigning a task to a resource in compliance with a general delivery plan defined by three variables comprising a scope variable, a resource variable and a duration variable, the method comprising:
a. receiving, at a computing device, (i) one or more constraints corresponding to each of a plurality of tasks, (ii) one or more constraints corresponding to each of a plurality of resources, and (iii) values defining two of the three variables of the general delivery plan;
b. optimizing, by the computer device, the general delivery plan by fixing two of the three variables with their respective values and determining an optimized value for the remaining variable without performing task assignment, wherein determining the optimized value of the remaining variable comprises:
formulating at least a first objective function that parameterizes the three variables; and
solving the first objective function to determine the optimized value of the remaining variable while satisfying the one or more constraints corresponding to the plurality of tasks, the one or more constraints corresponding to the plurality of resources and the values of the two fixed variables,
wherein the values of the three variables respectively define (i) the scope variable representing a subset of the plurality of tasks selected for execution, (ii) the resource variable representing a subset of the plurality of resources selected for completing the subset of tasks, and (iii) the duration variable representing a time frame for completing the subset of tasks;
c. sequentially assigning, by the computer device, a task to a resource when the resource becomes available based on optimization by solving a second objective function while satisfying one or more constraints associated with the task, one or more constraints associated with the resource, and the values of the three variables of the general delivery plan from step b,
wherein determining the task for assignment to the resource comprises selecting the task from the subset of tasks defined by the scope variable, selecting the resource from the subset of resources defined by the resource variable and completing the task by the resource within the time frame defined by the duration variable;
wherein the values of the three variables of the general delivery plan are set in step b prior to sequentially assigning a task to a resource in step c; and
d. repeating, using the computer device, step (c) when a new resource becomes available and requires task assignment.

2. (canceled)

3. The computer-implemented method of claim 1, wherein the resources comprise human resources and the one or more constraints corresponding to each human resource include performance constraints.

4. The computer-implemented method of claim 3, wherein the performance constraints are determined based on historical performance data associated with the respective human resource.

5. The computer-implemented method of claim 1, wherein the one or more constraints corresponding to each task comprise a start date or date range, an end date or date range, a resource constraint, a cost constraint, a location constraint, a dependency constraint, or a combination thereof.

6. The computer-implemented method of claim 1, wherein the resources comprise one or more human resources, one or more physical resources, or a combination thereof.

7. The computer-implemented method of claim 1, wherein the resources comprises one or more physical resources including one or more computer resources, one or more geographic locations, one or more supply materials, one or more equipment items, or a combination thereof.

8. The computer-implemented method of claim 1, wherein the one or more constraints corresponding to each resource comprise a skill level of each team member, availability of each team member or past performance rating of each team member, or a combination thereof.

9. The computer-implemented method of claim 1, wherein the values of the duration variable and the resource variable are defined by the user, based on which the first objective function is solved to determine a value for the scope variable.

10. The computer-implemented method of claim 9, wherein the first objective function is configured to maximize the number of critical tasks, maximize the number of tasks with highest business value, maximize the number of tasks with highest return-on-investment, or minimize the number of tasks with highest risk, or a combination thereof.

11. The computer-implemented method of claim 1, wherein the values of the resource variable and the scope variable are defined by the user, based on which the first objective function is solved to determine a value for the duration variable.

12. The computer-implemented method of claim 11, wherein the first objective function is configured to minimize the time for completing the tasks.

13. The computer-implemented method of claim 1, wherein the values of the duration variable and the scope variable are defined by the user, based on which the first objective function is solved to determine a value for the resource variable.

14. The computer-implemented method of claim 13, wherein the first objective function is configured to minimize resource fragmentation, or minimize resource cost, or a combination thereof.

15. The computer-implemented method of claim 1, wherein the second objective function is configured to minimize the amount of time to complete the tasks.

16. (canceled)

17. (canceled)

18. The computer-implemented method of claim 1, wherein solving the first objective function formulates the task delivery plan by determining a value for each variable from the three variables that is not defined by the user.

19. The computer-implemented method of claim 18, wherein solving the second objective function assigns tasks to resources, one resource at a time, to meet the task delivery plan.

20. The computer-implemented method of claim 1, further comprising using at least one of linear programming or constraint programming to solve at least one of the first objective function or the second objective function.

21. The computer-implemented method of claim 1, further comprising formulating the first or second objective function based on at least one optimization goal supplied by the user.

22. A computer program product, tangibly embodied in a non-transitory machine-readable storage device, for dynamically assigning a task to a resource in compliance with a general delivery plan defined by three variables comprising a scope variable, a resource variable and a duration variable, the computer program product including instructions being operable to cause data processing apparatus to:
a. receive (i) one or more constraints corresponding to each of a plurality of tasks, (ii) one or more constraints corresponding to each of a plurality of resources, and (iii) values defining two of the three variables of the general delivery plan;
b. optimize the general delivery plan by fixing two of the three variables with their respective values received and determining an optimized value for the remaining variable without performing task assignment, wherein determining the optimized value of the remaining variable comprises:
formulate at least a first objective function that parameterizes the three variables; and solve the first objective function to determine the optimized value of the remaining variable while satisfying the one or more constraints corresponding to the plurality of tasks, the one or more constraints corresponding to the plurality of resources and the values of the two fixed variables,
wherein the values of the three variables respectively define: (i) the scope variable representing a subset of the plurality of tasks selected for execution, (ii) the resource variable representing a subset of the plurality of resources selected for completing the subset of tasks, and (iii) the duration variable representing a time frame for completing the subset of tasks;
c. sequentially assign a task to a resource when the resource becomes available based on optimization by solving a second objective function while satisfying one or more constraints associated with the task, one or more constraints associated with the resource, and the values of the three variables of the general delivery plan from step b,
wherein determining the task for assignment to the resource comprises selecting the task from the subset of tasks defined by the scope variable, selecting the resource from the subset of resources defined by the resource variable and completing the task by the resource within the time frame defined by the duration variable;
wherein the values of the three variables of the general delivery plan are set in step b prior to sequentially assigning a task to a resource in step c; and
d. repeat step (c) when a new resource becomes available and requires task assignment.

23. (canceled)

24. The computer-implemented method of claim 1, wherein the first and second objective functions are the same function.

25. The computer-implemented method of claim 1, wherein the first and second objective functions are different functions.
